(19) United States
(12) Patent Application Publication
(10) Pub. No.: US 2011/0025289 A1
(43) Pub. Date: Feb. 3, 2011

(54) TWO-STAGE SWITCHING POWER SUPPLY

(75) Inventors: Cheng-Ping Wang, Taoyuan Hsien (TW); Cheng-Yi Lo, Taoyuan Hsien (TW); Chang-Chieh Yu, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/845,377

(22) Filed: Jul. 28, 2010

(30) Foreign Application Priority Data
Jul. 31, 2009 (TW) 098125997

(51) Int. Cl. G05F 1/563

(52) U.S. Cl. 323/285

(57) ABSTRACT

A two-stage switching power supply includes a first-stage power circuit, a bus capacitor, a second-stage power circuit and a power control unit. The first-stage power circuit is connected to a power bus for receiving an input voltage, and includes a first switching circuit. The input voltage is converted into a bus voltage by alternately conducting and shutting off the first switching circuit. The second-stage power circuit is connected to the power bus for receiving the bus voltage, and includes a second switching circuit. The power control unit is used for controlling operations of the first switching circuit and the second switching circuit. The bus voltage is dynamically adjusted according to electricity consumption amount of the system circuit under control of the power control unit. An operating mode of the second switching circuit of the second-stage power circuit is changed according to the electricity consumption amount of the system circuit.

### FIELD OF THE INVENTION

The present invention relates to a power supply, and more particularly to a two-stage switching power supply.

### BACKGROUND OF THE INVENTION

With increasing industrial development, diverse electronic devices are used to achieve various purposes. An electronic device comprises a plurality of electronic components. Generally, different kinds of electronic components are operated by using different voltages.

As known, a power supply is essential for many electronic devices such as personal computers, industrial computers, servers, communication products or network products. Usually, the user may simply plug a power supply into an AC wall outlet commonly found in most homes or offices so as to receive an AC voltage. The power supply will convert the AC voltage into a regulated DC output voltage for powering the electronic device. The regulated DC output voltage is transmitted to the electronic device through a power cable.

Generally, power supply apparatuses are classified into two types, i.e. a linear power supply and a switching power supply (SPS). A linear power supply principally comprises a transformer, a diode rectifier and a capacitor filter. The linear power supply is advantageous due to its simplified circuitry and low fabricating cost. Since the linear power supply has bulky volume, the linear power supply is not applicable to a slim-type electronic device. In addition, the converting efficiency of the linear power supply is too low to comply with the power-saving requirements. In comparison with the linear power supply, the switching power supply has reduced volume but increased converting efficiency. That is, the switching power supply is applicable to the slim-type electronic device and may meet with the power-saving requirements.

The conventional two-stage switching power supply comprises a first-stage power circuit and a second-stage power circuit. By the first-stage power circuit, an input AC voltage is converted into a bus voltage having a constant voltage value. By the second-stage power circuit, the bus voltage is converted into an output voltage having a rated voltage value, which is required for powering an electronic device. If the input AC voltage is subject to a sudden variation or interruption, the output voltage is also subject to a sudden variation or interruption, and thus the output voltage fails to be maintained at the rated voltage value. Generally, the magnitude of the output voltage is dependent on the electricity consumption of the electronic device. As the electricity consumption amount of the electronic device is increased, the difference between the practical value and the rated value of the output voltage is increased if the input AC voltage is subject to a sudden variation or interruption. In addition, if the input AC voltage is subject to a sudden variation or interruption, the output voltage is rapidly decreased. As the electricity consumption amount of the electronic device is increased, the output voltage is decreased at a faster speed. Conventionally, the second-stage power circuit of the two-stage switching power supply is operated in a PWM mode or a resonant mode according to the rated electricity amount. Even if the output electricity amount of the second-stage power circuit of the two-stage switching power supply is different, the operating mode is maintained unchanged. As such, the operating efficiency of the second-stage power circuit is usually insufficient. Generally, the operating efficiency of the second-stage power circuit is relatively higher once the electricity consumption amount of the electronic device is beyond a specified value (e.g. the rated electricity consumption amount).

Therefore, there is a need of providing an improved two-stage switching power supply so as to obviate the drawbacks encountered from the prior art.

### SUMMARY OF THE INVENTION

It is an object of the present invention to provide two-stage switching power supply having high operating efficiency when the electricity consumption amount of the system circuit is high or low.

In accordance with an aspect of the present invention, there is provided a two-stage switching power supply for receiving an input voltage and generating an output voltage or an output current to a system circuit. The two-stage switching power supply includes a first-stage power circuit, a bus capacitor, a second-stage power circuit and a power control unit. The first-stage power circuit is connected to a power bus for receiving an input voltage, and includes a first switching circuit. The input voltage is converted into a bus voltage by alternately conducting and shutting off the first switching circuit. The bus capacitor is interconnected between the power bus and a first common terminal for storing electrical energy. The second-stage power circuit is connected to the power bus for receiving the bus voltage, and includes a second switching circuit. The bus voltage is converted into the output voltage or the output current by alternately conducting and shutting off the second switching circuit. The power control unit is connected to a control terminal of the first switching circuit of the first-stage power circuit, a control terminal of the second switching circuit of the second-stage power circuit and a power bus for controlling operations of the first switching circuit and the second switching circuit. The bus voltage is dynamically adjusted according to electricity consumption amount of the system circuit under control of the power control unit. An operating mode of the second switching circuit of the second-stage power circuit is changed according to the electricity consumption amount of the system circuit.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram of a two-stage switching power supply according to an embodiment of the present invention;

FIG. 2 is a plot illustrating the relation between the power-consuming status and the electricity consumption amount of a system circuit according to an embodiment of the present invention;

FIG. 3 is a plot illustrating the relation between the power-consuming status and the electricity consumption amount of a system circuit according to another embodiment of the present invention;

FIG. 4 is a plot illustrating the relation between the bus voltage of the two-stage switching power supply and the electricity consumption amount of a system circuit according to an embodiment of the present invention;

FIG. 5 is a plot illustrating the relation between the bus voltage of the two-stage switching power supply and the electricity consumption amount of a system circuit according to another embodiment of the present invention;

FIG. 6 is a schematic detailed circuit diagram of a first exemplary two-stage switching power supply as shown in FIG. 1;

FIG. 7 is a schematic detailed circuit diagram of a second exemplary two-stage switching power supply as shown in FIG. 1;

FIG. 8 is a schematic detailed circuit diagram of a third exemplary two-stage switching power supply as shown in FIG. 1; and

FIG. 9 is a schematic detailed circuit diagram of a fourth exemplary two-stage switching power supply as shown in FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

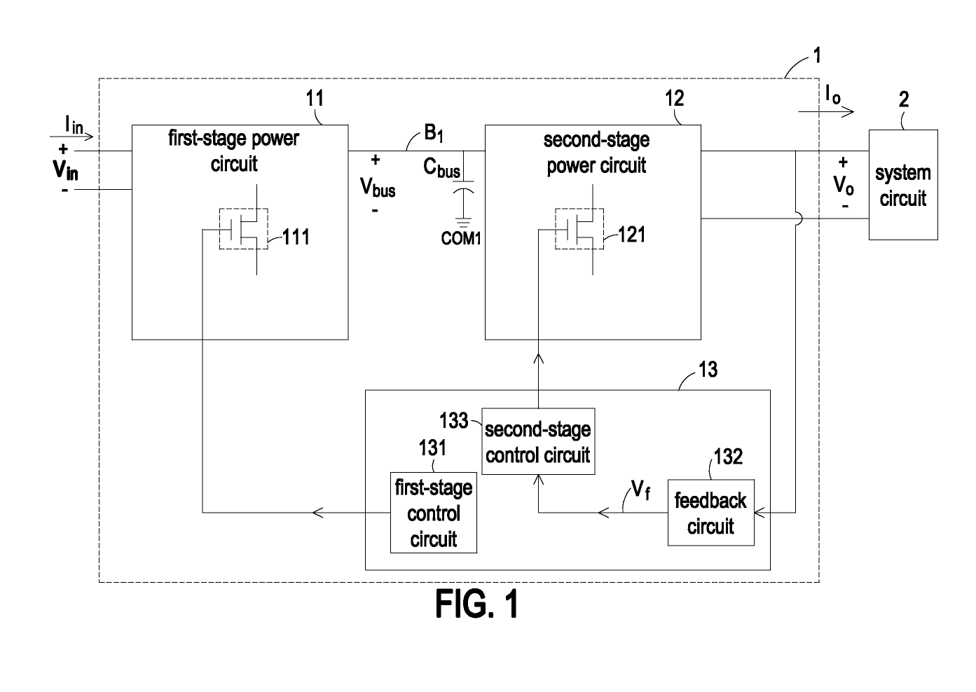

FIG. 1 is a schematic circuit diagram of a two-stage switching power supply according to an embodiment of the present invention. The two-stage switching power supply 1 is used for receiving an input voltage Vᵢₙ and generating an output voltage Vₒ or an output current Iₒ to a system circuit 2 of an electronic device. The two-stage switching power supply 1 comprises a first-stage power circuit 11, a second-stage power circuit 12, a power control unit 13 and a bus capacitor C_{bus}.

The first-stage power circuit 11 comprises a first switching circuit 111. The control terminal of the first-stage power circuit 11 is connected to a first-stage control circuit 131 of the power control unit 13. The first-stage power circuit 11 is connected to a power bus B₁ and the first-stage control circuit 131 of the power control unit 13. When the first switching circuit 111 is alternatively conducted or shut off, the input voltage Vᵢₙ is converted into a bus voltage V_{bus} by the first-stage power circuit 11.

The second-stage power circuit 12 comprises a second switching circuit 121. The control terminal of the second switching circuit 121 is connected to a second-stage control circuit 133 of the power control unit 13. The second-stage power circuit 12 is connected to the power bus B₁, the system circuit 2 and the second-stage control circuit 133 of the power control unit 13. When the second switching circuit 121 is alternatively conducted or shut off, the bus voltage V_{bus} is converted into the output voltage Vₒ or the output current Iₒ by the second-stage power circuit 12.

A first end of the bus capacitor C_{bus} is connected to the power bus B₁, the power output terminal of the first-stage power circuit 11 and the power input terminal of the second-stage power circuit 12. A second end of the bus capacitor C_{bus} is connected to a first common terminal COM₁. The bus capacitor C_{bus} is used for storing electrical energy.

The power control unit 13 comprises the first-stage control circuit 131, a feedback circuit 132 and the second-stage control circuit 133. The first-stage control circuit 131 is connected to the control terminal of the first-stage power circuit 11 and the power bus B₁ (not shown in FIG. 1). The first-stage control circuit 131 receives the bus voltage V_{bus} and generates a first power factor correction signal V_{PFC1}. According to the first power factor correction signal V_{PFC1}, the first-stage control circuit 131 controls operations of the first switching circuit 111. As a consequence, the magnitude of the bus voltage V_{bus} is linearly or stepwise altered as the electricity consumption amount Pₒ of the system circuit 2 (i.e. the loading of the second-stage power circuit 12). The feedback circuit 132 is connected to the power output terminal of the second-stage power circuit 12. According to the output voltage Vₒ or the output current Iₒ outputted from the second-stage power circuit 12, the feedback circuit 132 generates a feedback signal V_{f}. The second-stage control circuit 133 is connected to the control terminal of the second switching circuit 121 and the feedback circuit 132. According to the feedback signal V_{f}, the second-stage control circuit 133 generates a first control signal V_{D1}. According to the first control signal V_{D1}, the second-stage control circuit 133 controls operations of the second switching circuit 121. Moreover, according to the electricity consumption amount Pₒ of the system circuit 2, the first control signal V_{D1} is dynamically adjusted to change the operating mode of the second switching circuit 121.

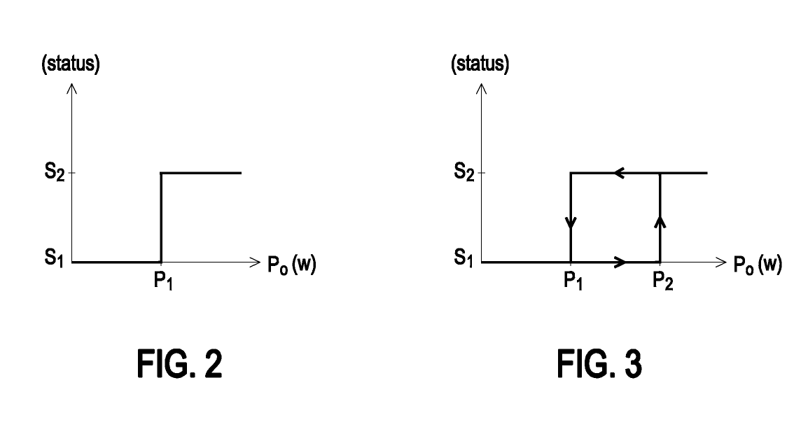

FIG. 2 is a plot illustrating the relation between the power-consuming status and the electricity consumption amount of a system circuit according to an embodiment of the present invention. Please refer to FIGS. 1 and 2. In a case that the electricity consumption amount Pₒ of the system circuit 2 is lower than a first electricity consumption amount P₁ (e.g. 10 W), the power control unit 13 will discriminate that the system circuit 2 is in a low electricity consumption status S₁. In the low electricity consumption status S₁, the second switching circuit 121 is operated in a pulse width modulation (PWM) mode under control of the second-stage control circuit 133 of the power control unit 13. By adjusting an on duration and an off duration (or a duty cycle) of the second switching circuit 121, the second-stage power circuit 12 receives the bus voltage V_{bus} and generates an output voltage Vₒ or an output current Iₒ having a rated value. Whereas, in a case that the electricity consumption amount Pₒ of the system circuit 2 is higher than the first electricity consumption amount P₁, the power control unit 13 will discriminate that the system circuit 2 is in a non-low electricity consumption status S₂. In the non-low electricity consumption status S₂, the second switching circuit 121 is operated in a resonant mode under control of the second-stage control circuit 133 of the power control unit 13. Meanwhile, the duty cycle of the second switching circuit 121 is set as a constant value (e.g. 0.5). By adjusting the operating frequency of the second switching circuit 121, the second-stage power circuit 12 receives the bus voltage V_{bus} and generates an output voltage Vₒ or an output current Iₒ having a rated value.

FIG. 3 is a plot illustrating the relation between the power-consuming status and the electricity consumption amount of a system circuit according to another embodiment of the present invention. Please refer to FIGS. 1, 2 and 3. In comparison with FIG. 2, the relation between the power-consuming status and the electricity consumption amount in FIG. 3 shows that a hysteresis occurs. In a case that the system circuit 2 is in the low electricity consumption status S₁ and the electricity consumption amount Pₒ of the system circuit 2 is increased to be higher than the first electricity consumption amount P₁ and lower than a second electricity consumption amount P₂, the power control unit 13 will discriminate that the system circuit 2 is in the low electricity consumption status S₁. Until the electricity consumption amount Pₒ of the system circuit 2 is continuously increased to be higher than the second electricity consumption amount P₂, the power control unit 13 will discriminate that the system circuit 2 is switched to the non-low electricity consumption status S₂. Whereas, in a case that the system circuit 2 is in the non-low electricity consumption status S₂ and the electricity consumption amount Pₒ of the system circuit 2 is decreased to be lower than the second electricity consumption amount P₂ and higher than the first electricity consumption amount P₁, the power control unit 13 will discriminate that the system circuit 2 is in the non-low electricity consumption status S₂. Until the electricity consumption amount Pₒ of the system circuit 2 is continuously decreased to be lower than the first electricity consumption amount P₁, the power control unit 13 will discriminate that the system circuit 2 is switched to the low electricity consumption status S₁. In other words, when the electricity consumption amount Pₒ of the system circuit 2 is changed at the first electricity consumption amount P₁ or the second electricity consumption amount P₂, hysteresis occurs. Due to hysteresis, the operating mode of the second-stage power circuit 12 will not be frequently switched, and thus the operation of the two-stage switching power supply 1 will be more stable. The first electricity consumption amount P₁ and the second electricity consumption amount P₂ could be determined as required. If the first electricity consumption amount P₁ is equal to the second electricity consumption amount P₂, no hysteresis occurs (see FIG. 2).

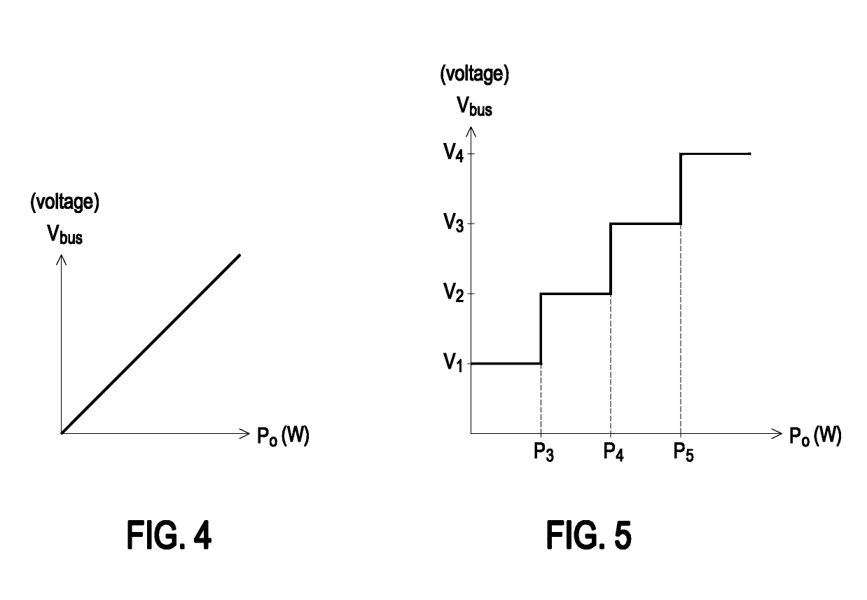

FIG. 4 is a plot illustrating the relation between the bus voltage of the two-stage switching power supply and the electricity consumption amount of a system circuit according to an embodiment of the present invention. As shown in FIG. 4, the magnitude of the bus voltage V_{bus} is linearly changed with the electricity consumption amount Pₒ of the system circuit 2. As the electricity consumption amount Pₒ of the system circuit 2 is increased, the duty cycle of the first switching circuit 111 is adjusted under control of the first-stage control circuit 131, so that the magnitude of the bus voltage V_{bus} is increased. In this embodiment, the ratio of the magnitude of the bus voltage V_{bus} to the electricity consumption amount Pₒ of the system circuit 2 is constant. In some embodiments, another relation (e.g. a stepwise relation) is created between the magnitude of the bus voltage V_{bus} and the electricity consumption amount Pₒ of the system circuit 2. Whereas, as the electricity consumption amount Pₒ of the system circuit 2 is decreased, the magnitude of the bus voltage V_{bus} is decreased. In this embodiment, the magnitude of the bus voltage V_{bus} is in direct proportion to the electricity consumption amount Pₒ of the system circuit 2.

FIG. 5 is a plot illustrating the relation between the bus voltage of the two-stage switching power supply and the electricity consumption amount of a system circuit according to another embodiment of the present invention. As shown in FIG. 5, the magnitude of the bus voltage V_{bus} is stepwise changed with the electricity consumption amount Pₒ of the system circuit 2. In a case that the electricity consumption amount Pₒ of the system circuit 2 is lower than a third electricity consumption amount P₃, the duty cycle of the first switching circuit 111 is adjusted under control of the first-stage control circuit 131, so that the magnitude of the bus voltage V_{bus} is maintained at a first voltage V₁. In a case that the electricity consumption amount Pₒ of the system circuit 2 is higher than the third electricity consumption amount P₃ and lower than a fourth electricity consumption amount P₄, the duty cycle of the first switching circuit 111 is adjusted under control of the first-stage control circuit 131, so that the magnitude of the bus voltage V_{bus} is maintained at a second voltage V₂. In a case that the electricity consumption amount Pₒ of the system circuit 2 is higher than the fourth electricity consumption amount P₄ and lower than a fifth electricity consumption amount P₅, the duty cycle of the first switching circuit 111 is adjusted under control of the first-stage control circuit 131, so that the magnitude of the bus voltage V_{bus} is maintained at a third voltage V₃. In a case that the electricity consumption amount Pₒ of the system circuit 2 is higher than the fifth electricity consumption amount P₅, the duty cycle of the first switching circuit 111 is adjusted under control of the first-stage control circuit 131, so that the magnitude of the bus voltage V_{bus} is maintained at a fourth voltage V₄.

Generally, as the electricity consumption amount Pₒ of the system circuit 2 is increased, the magnitude of the bus voltage V_{bus} is increased. According to the rated output power value Pₐ of the two-stage switching power supply 1, the power control unit 13 defines a plurality of electricity consumption regions. As shown in FIG. 5, four electricity consumption regions are defined. In the first electricity consumption region, the electricity consumption amount Pₒ of the system circuit 2 is lower than the third electricity consumption amount P₃. In the second electricity consumption region, the electricity consumption amount Pₒ of the system circuit 2 is higher than the third electricity consumption amount P₃ and lower than the fourth electricity consumption amount P₄. In the third electricity consumption region, the electricity consumption amount Pₒ of the system circuit 2 is higher than the fourth electricity consumption amount P₄ and lower than the fifth electricity consumption amount P₅. In the fourth electricity consumption region, the electricity consumption amount Pₒ of the system circuit 2 is higher than the fifth electricity consumption amount P₅. According to the electricity consumption region corresponding to the electricity consumption amount Pₒ of the system circuit 2, the magnitude of the bus voltage V_{bus} is determined.

In an embodiment, the rated output power value Pₐ of the two-stage switching power supply 1, the third electricity consumption amount P₃, the fourth electricity consumption amount P₄ and the fifth electricity consumption amount P₅ are arranged in the order of Pₐ>P₅>P₄>P₃. The third electricity consumption amount P₃ is one fourth of the rated output power value Pₐ of the two-stage switching power supply 1, i.e. P₃=¼ Pₐ. The fourth electricity consumption amount P₄ is two fourth of the rated output power value Pₐ of the two-stage switching power supply 1, i.e. P₄= 2/4 Pₐ. The fifth electricity consumption amount P₅ is three fourth of the rated output power value Pₐ of the two-stage switching power supply 1, i.e. P₅=¾ Pₐ. Similarly, as the electricity consumption amount Pₒ of the system circuit 2 is increased, the magnitude of the bus voltage V_{bus} is increased correspondingly.

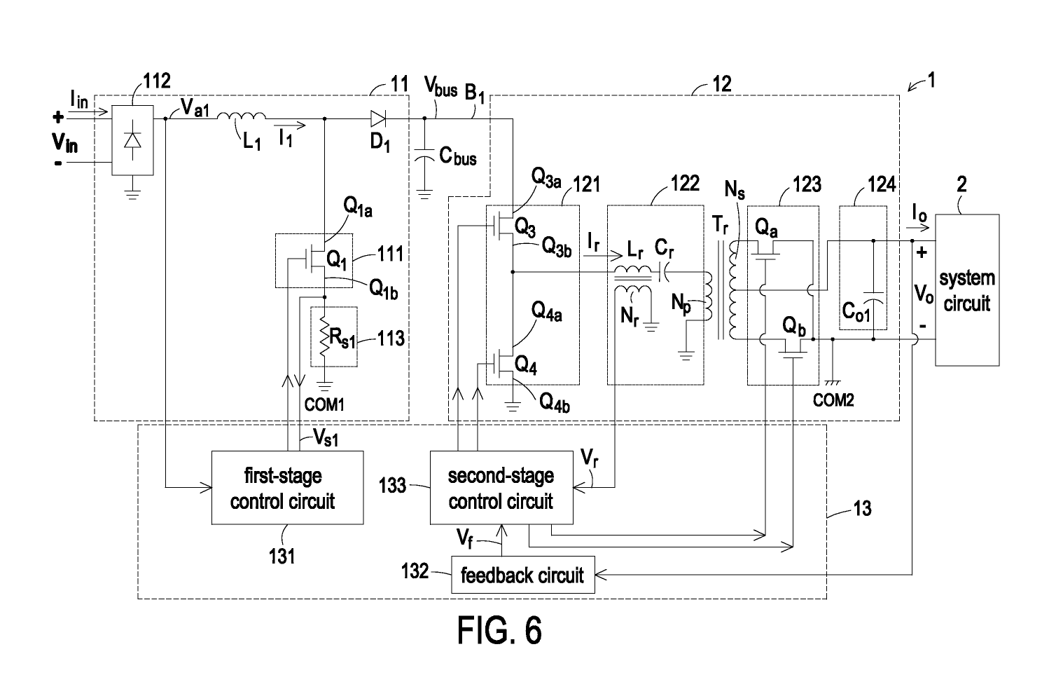

FIG. 6 is a schematic detailed circuit diagram of a first exemplary two-stage switching power supply as shown in FIG. 1. As shown in FIG. 6, the two-stage switching power supply 1 comprises a first-stage power circuit 11, a second-stage power circuit 12, a power control unit 13 and a bus capacitor C_{bus}.

The first-stage power circuit 11 comprises the first switching circuit 111, a first input rectifier circuit 112, a first current detecting circuit 113, a first boost inductor L₁ and a first diode D₁. The first switching circuit 111 comprises a first switch element Q₁. The first current detecting circuit 113 comprises a first current detecting resistor Rₛ₁.

The output terminal of the first input rectifier circuit 112 is connected to a first end of the first boost inductor L₁ and the first-stage control circuit 131 of the power control unit 13. The first input rectifier circuit 112 is used for rectifying the input voltage Vᵢₙ, thereby generating a first rectified input voltage Vₐ₁. The waveform of the first rectified input voltage Vₐ₁ is obtained by rectifying the full-wave of the input voltage Vᵢₙ. The second end of the first boost inductor L₁ is connected to the anode of the first diode D₁ and a first terminal Q₁ₐ of the first switch element Q₁. The cathode of the first diode D₁ is connected to the power bus B₁ and the bus capacitor C_{bus}. A second terminal Q_{1b} of the first switch element Q₁ is connected to a first end of the first current detecting resistor Rₛ₁. A second end of the first current detecting resistor Rₛ₁ is connected to the first common terminal COM₁. The control terminal of the first switch element Q₁ is connected to the first-stage control circuit 131 of the power control unit 13.

The waveform of the first rectified input voltage Vₐ₁ is similar to the waveform of the input voltage Vᵢₙ. For example, the first rectified input voltage Vₐ₁ has a sine-shaped waveform. According to the first rectified input voltage Vₐ₁ and the electricity consumption amount Pₒ of the system circuit 2, the first-stage control circuit 131 generates the first power factor correction signal V_{PFC1}. By alternately conducting and shutting off the first switch element Q₁ according to the first power factor correction signal V_{PFC1}, the envelop curve of the input current is similar to the waveform of the input voltage V₁. As a consequence, the two-stage switching power supply 1 of the present invention has a good power factor correction function. Moreover, the duty cycle of the first switch element Q₁ is adjusted by the first-stage control circuit 131 according to the electricity consumption amount Pₒ of the system circuit 2, so that the magnitude of the bus voltage V_{bus} is linearly or stepwise changed.

In a case that the first power factor correction signal V_{PFC1} is in an enabling status (e.g. at a high-level voltage), the first switch element Q₁ is conducted. As such, the first boost inductor L₁ is charged by the first rectified input voltage Vₐ₁, and the magnitude of a first current I₁ passing through the first boost inductor L₁ is increased. At the same time, the charging current flows through the first switch element Q₁ and the first current detecting resistor Rₛ₁. When the charging current flows through the first current detecting resistor Rₛ₁, the first current detecting circuit 113 generates a first current detecting signal Vₛ₁. The product of the first current detecting signal Vₛ₁ and the bus voltage V_{bus} is related to the electricity consumption amount Pₒ of the system circuit 2. As the electricity consumption amount Pₒ is increased, the product of the first current detecting signal Vₛ₁ and the bus voltage V_{bus} is increased.

Whereas, in a case that the first power factor correction signal V_{PFC1} is in a disabling status (e.g. at a low-level voltage), the first switch element Q₁ is shut off. As such, the first boost inductor L₁ discharges to the bus capacitor C_{bus} through the first diode D₁. As such, the magnitude of the first current I₁ passing through the first boost inductor L₁ is decreased.

In an embodiment, the first-stage control circuit 131 discriminates the power-consuming status of the electricity consumption amount Pₒ of the system circuit 2 according to the product of the first current detecting signal Vₛ₁ and the bus voltage V_{bus}. If the magnitude of the bus voltage V_{bus} is constant, the first current detecting signal Vₛ₁ is related to the electricity consumption amount Pₒ of the system circuit 2. Next, according to the power-consuming status of the electricity consumption amount Pₒ of the system circuit 2 and the waveform of the first rectified input voltage Vₐ₁, the duty cycle of the first switch element Q₁ is controlled by the first-stage control circuit 131. As a consequence, the magnitude of the bus voltage V_{bus} is linearly or stepwise altered as the electricity consumption amount Pₒ of the system circuit 2. The relation between the magnitude of the bus voltage V_{bus} and the electricity consumption amount Pₒ of the system circuit 2 has been described above.

Please refer to FIG. 6 again. The second-stage power circuit 12 comprises the second switching circuit 121, a resonant circuit 122, an isolation transformer Tᵣ, an output rectifier circuit 123 and an output filter circuit 124. The second switching circuit 121 comprises a third switch element Q₃ and a fourth switch element Q₄. A first terminal Q₃ₐ of the third switch element Q₃ is connected to the power bus B₁ and the bus capacitor C_{bus}. A second terminal Q_{3b} of the third switch element Q₃ is connected to a first terminal Q₄ₐ of the fourth switch element Q₄ and the resonant circuit 122. A second terminal Q_{4b} of the fourth switch element Q₄ is connected to the first common terminal COM₁. The control terminals of the third switch element Q₃ and the fourth switch element Q₄ are connected to the second-stage control circuit 133. According to the feedback signal V_{f}, the second-stage control circuit 133 generates a first control signal V_{D1} and a second control signal V_{D2}. According to the first control signal V_{D1}, the third switch element Q₃ is conducted or shut off. According to the second control signal V_{D2}, the fourth switch element Q₄ is conducted or shut off. As such, the electrical energy of the bus voltage V_{bus} will be selectively transmitted to the resonant circuit 122 and the primary winding assembly Nₚ of the isolation transformer Tᵣ through the third switch element Q₃ or the fourth switch element Q₄. As such, both ends of the primary winding assembly Nₚ are subject to a voltage variation. Due to the voltage variation, a secondary winding assembly Nₛ of the isolation transformer Tᵣ generates an induction voltage.

The resonant circuit 122 comprises a resonant inductor Lᵣ and a resonant capacitor Cᵣ. The resonant inductor Lᵣ and the resonant capacitor Cᵣ are serially connected between the second switching circuit 121 and the primary winding assembly Nₚ of the isolation transformer Tᵣ. By adjusting the operating mode of the second switching circuit 121 under control the second-stage control circuit 133, a resonant relation between the resonant circuit 122 and the primary winding assembly Nₚ of the isolation transformer Tᵣ is established. When the second switching circuit 121 is operated in the resonant mode, a resonant relation (e.g. a LLC resonant relation) is established between the resonant circuit 122 and the primary winding assembly Nₚ of the isolation transformer Tᵣ at a certain operating frequency. In some operating frequencies, the resonant relation is created by the resonant circuit 122 itself but the primary winding assembly Nₚ of the isolation transformer Tᵣ does not participate in the resonant relation (e.g. a LC resonant relation). As such, both ends of the primary winding assembly Nₚ are subject to a voltage variation. Due to the voltage variation, a secondary winding assembly Nₛ of the isolation transformer Tᵣ generates an induction voltage. According to the electricity consumption amount Pₒ of the system circuit 2, the first control signal V_{D1} and the second control signal V_{D2} are adjusted under control of the second-stage control circuit 133, so that the second switching circuit 121 is operated in the PWM mode. At the same time, no resonant relation is established between the resonant circuit 122 and the primary winding assembly Nₚ of the isolation transformer Tᵣ. Under control of the second-stage control circuit 133, the operating frequency of the second switching circuit 121 is determined and the duty cycle of the second switching circuit 121 is adjusted, so that the bus voltage V_{bus} is converted into the output voltage Vₒ or the output current Iₒ by the second-stage power circuit 12.

When the second switching circuit 121 is operated in the resonant mode, a resonant relation is established between the resonant circuit 122 and the primary winding assembly Nₚ of the isolation transformer Tᵣ. Under control of the second-stage control circuit 133, the duty cycle of the second switching circuit 121 is adjusted to a constant value (e.g. 0.5). By adjusting the operating frequency of the second switching circuit 121, the second-stage power circuit 12 receives the bus voltage V_{bus} and generates a resonant response. According to the operating frequency of the second switching circuit 121, the second-stage power circuit 12 generates the output voltage Vₒ or the output current Iₒ.

In an embodiment, the output rectifier circuit 123 is a synchronous rectifier circuit. The output rectifier circuit 123 comprises a first rectifying switch element Qₐ and a second rectifying switch element Q_{b}. The first rectifying switch element Qₐ is interconnected between a first end of the secondary winding assembly Nₛ of the isolation transformer Tᵣ and a second common terminal COM₂. The second rectifying switch element Q_{b} is interconnected between a second end of the secondary winding assembly Nₛ of the isolation transformer Tᵣ and the second common terminal COM₂. The control terminals of the first rectifying switch element Qₐ and the second rectifying switch element Q_{b} are connected to the second-stage control circuit 133. According to a first rectifying signal Vₖ₁ and a second rectifying signal Vₖ₂ generated by the second-stage control circuit 133, the first rectifying switch element Qₐ and the second rectifying switch element Q_{b} are selectively conducted or shut off, thereby rectifying the induction voltage that is generated by the secondary winding assembly Nₛ of the isolation transformer Tᵣ.

In an embodiment, the output filter circuit 124 comprises a first capacitor Cₒ₁. A first end of the first capacitor Cₒ₁ is connected to the second common terminal COM₂ and the output rectifier circuit 123. A second end of the first capacitor Cₒ₁ is connected to a center-tapped head of the secondary winding assembly Nₛ of the isolation transformer Tᵣ. The output filter circuit 124 is used for filtering the voltage that is rectified by the output rectifier circuit 123, thereby generating the output voltage Vₒ or the output current Iₒ having a rated value to the system circuit 2.

In this embodiment, the induction coil Nᵣ of the resonant inductor Lᵣ is subject to induction by the induction current Iᵣ, thereby generating a resonant current detecting signal Vᵣ. According to the resonant current detecting signal Vᵣ, the second-stage control circuit 133 discriminates whether the second-stage power circuit 12 is in an over current protection (OCP) status, thereby protecting normal operations of the second-stage power circuit 12. After the feedback signal V_{f} generated from the feedback circuit 132 is received by the second-stage control circuit 133, the feedback signal V_{f} is compared with a reference voltage by a comparator (not shown) of the second-stage control circuit 133. In a case that the feedback signal V_{f} is higher than the reference voltage (i.e. under a light loading), the second switching circuit 121 is operated in the PWM mode. In a case that the feedback signal V_{f} is lower than the reference voltage, the second switching circuit 121 is operated in a frequency-variation mode. Next, according to the electricity consumption amount Pₒ of the system circuit 2 and the corresponding power-consuming status, the first control signal V_{D1} and the second control signal V_{D2} are dynamically adjusted, so that the second switching circuit 121 is operated in the PWM mode or the resonant mode. The relation between the electricity consumption amount Pₒ of the system circuit 2, the power-consuming status and operating mode of the second switching circuit 121 has been described above.

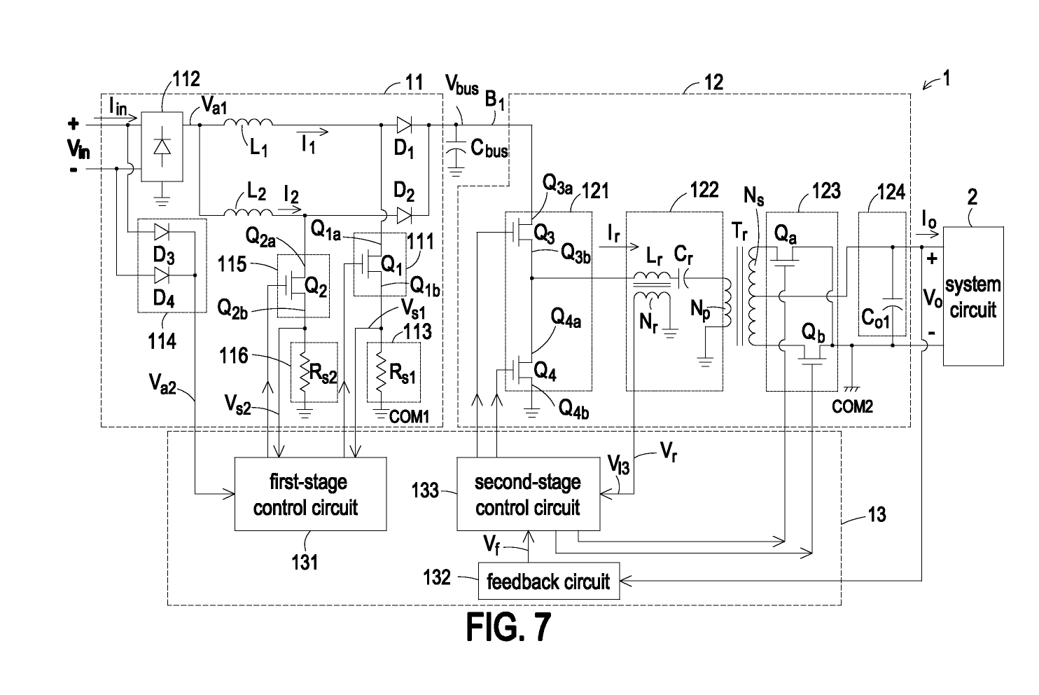

FIG. 7 is a schematic detailed circuit diagram of a second exemplary two-stage switching power supply as shown in FIG. 1. In comparison with FIG. 6, the first-stage power circuit 11 further comprises a second input rectifier circuit 114, a third switching circuit 115, a second current detecting circuit 116, a second boost inductor L₂ and a second diode D₂. The third switching circuit 115 comprises a second switch element Q₂. The second current detecting circuit 116 comprises a second current detecting resistor Rₛ₂. The second input rectifier circuit 114 comprises a third diode D₃ and a fourth diode D₄.

The anode of the third diode D₃ is connected to a first input terminal of the first input rectifier circuit 112. The cathode of the third diode D₃ is connected to the cathode of the fourth diode D₄ and the first-stage control circuit 131. The anode of the fourth diode D₄ is connected to a second input terminal of the first input rectifier circuit 112. The cathode of the fourth diode D₄ is connected to the cathode of the third diode D₃ and the first-stage control circuit 131. By the third diode D₃ and the fourth diode D₄, the input voltage Vᵢₙ is rectified into a second rectified input voltage Vₐ₂. The waveform of the second rectified input voltage Vₐ₂ is obtained by rectifying the full-wave of the input voltage Vᵢₙ.

The connections between the second switch element Q₂ of the third switching circuit 115, the second current detecting resistor Rₛ₂ of the second current detecting circuit 116, the second boost inductor L₂ and the second diode D₂ are similar to the connections between the first switch element Q₁ of the first switching circuit 111, the first current detecting resistor Rₛ₁ of the first current detecting circuit 113, the first boost inductor L₁ and the first diode D₁, and are not redundantly described herein.

The first end of the second boost inductor L₂ is connected to the output terminal of the first input rectifier circuit 112 and the first end of the first boost inductor L₁. The second end of the second boost inductor L₂ is connected to the anode of the second diode D₂ and a first terminal Q₂ₐ of the second switch element Q₂. The cathode of the second diode D₂ is connected to the power bus B₁, the bus capacitor C_{bus} and the cathode of the first diode D₁. A second terminal Q_{2b} of the second switch element Q₂ is connected to a first end of the second current detecting resistor Rₛ₂. A second end of the second current detecting resistor Rₛ₂ is connected to the first common terminal COM₁. The control terminal of the second switch element Q₂ is connected to the first-stage control circuit 131 of the power control unit 13.

In comparison with FIG. 6, the first-stage control circuit 131 of FIG. 7 is also connected to the output terminal of the second input rectifier circuit 114. The waveform of the second rectified input voltage Vₐ₂ is also similar to the waveform of the input voltage Vᵢₙ. According to the second rectified input voltage Vₐ₂ and the electricity consumption amount Pₒ of the system circuit 2, the first-stage control circuit 131 generates a first power factor correction signal V_{PFC1} and a second power factor correction signal V_{PFC2}. By sequentially or alternately conducting the first switch element Q₁ and the second switch element Q₂ according to the first power factor correction signal V_{PFC1} and the second power factor correction signal V_{PFC2}, the envelop curve of the input current is similar to the waveform of the input voltage Vᵢₙ. As a consequence, the two-stage switching power supply 1 of the present invention has a good power factor correction function. Moreover, the duty cycles of the first switch element Q₁ and the second switch element Q₂ are adjusted by the first-stage control circuit 131 according to the electricity consumption amount Pₒ of the system circuit 2, so that the magnitude of the bus voltage V_{bus} is linearly or stepwise changed.

In a case that the first power factor correction signal V_{PFC1} is in an enabling status but the second power factor correction signal V_{PFC2} is in a disabling status, the first switch element Q₁ is conducted. As such, the first boost inductor L₁ is charged by the first rectified input voltage Vₐ₁, and the magnitude of a first current I₁ passing through the first boost inductor L₁ is increased. At the same time, the charging current flows through the first switch element Q₁ and the first current detecting resistor Rₛ₁. When the charging current flows through the first current detecting resistor Rₛ₁, the first current detecting circuit 113 generates a first current detecting signal Vₛ₁. Meanwhile, the magnitude of the first current detecting signal Vₛ₁ is in direct proportion to the electricity consumption amount Pₒ of the system circuit 2. As the electricity consumption amount Pₒ is increased, the magnitude of the first current detecting signal Vₛ₁ is increased. Since the second power factor correction signal V_{PFC2} is in the disabling status, the second switch element Q₂ is shut off. As such, the second boost inductor L₂ discharges to the bus capacitor C_{bus} through the second diode D₂. As such, the magnitude of the second current I₂ passing through the second boost inductor L₂ is decreased.

In a case that the second power factor correction signal V_{PFC2} is in the enabling status but the first power factor correction signal V_{PFC2} is in the disabling status, the second switch element Q₂ is conducted. As such, the second boost inductor L₂ is charged by the first rectified input voltage Vₐ₁, and the magnitude of a second current I₂ passing through the second boost inductor L₂ is increased. At the same time, the charging current flows through the second switch element Q₂ and the second current detecting resistor Rₛ₂. When the charging current flows through the second current detecting resistor Rₛ₂, the second current detecting circuit 116 generates a second current detecting signal Vₛ₂. Meanwhile, the magnitude of the second current detecting signal Vₛ₂ is in direct proportion to the electricity consumption amount Pₒ of the system circuit 2. Since the first power factor correction signal V_{PFC1} is in the disabling status, the first switch element Q₁ is shut off. As such, the first boost inductor L₁ discharges to the bus capacitor C_{bus} through the first diode D₁. As such, the magnitude of the first current I₁ passing through the first boost inductor L₁ is decreased.

In an embodiment, the first-stage control circuit 131 discriminates the power-consuming status of the electricity consumption amount Pₒ of the system circuit 2 according to the product of the bus voltage V_{bus} and the sum of the first current detecting signal Vₛ₁ and the second current detecting signal Vₛ₂. Next, according to the power-consuming status of the electricity consumption amount Pₒ of the system circuit 2 and the waveform of the second rectified input voltage Vₐ₂, the duty cycles of the first switch element Q₁ and the second switch element Q₂ are controlled. As a consequence, the magnitude of the bus voltage V_{bus} is linearly or stepwise altered as the electricity consumption amount Pₒ of the system circuit 2. The relation between the magnitude of the bus voltage V_{bus} and the electricity consumption amount Pₒ of the system circuit 2 has been described above.

Since the first power factor correction signal V_{PFC1} and the second power factor correction signal V_{PFC2} are not simultaneously in the enabling status, the first switch element Q₁ and the second switch element Q₂ are not simultaneously conducted. In other words, the first switch element Q₁ and the second switch element Q₂ are successively or alternately conducted in different time intervals. Since the magnitude of the input current Iᵢₙ of FIG. 7 is relatively lower and distributed in different time intervals, the envelop curve of the input current Iᵢₙ is more similar to the waveform of the input voltage Vᵢₙ in comparison with the envelop curve of the input current Iᵢₙ of FIG. 6.

Since the two-stage switching power supply 1 of FIG. 7 includes the first switch element Q₁ and the second switch element Q₂, the two-stage switching power supply 1 of FIG. 7 could output more electricity capability. Moreover, since the first switch element Q₁ and the second switch element Q₂ are successively or alternately conducted, the operating temperatures of the first switch element Q₁, the second switch element Q₂, the first current detecting resistor Rₛ₁, the second current detecting resistor Rₛ₂, the first boost inductor L₁, the second boost inductor L₂, the first diode D₁ and the second diode D₂ are reduced. As such, the use life of the two-stage switching power supply 1 is prolonged.

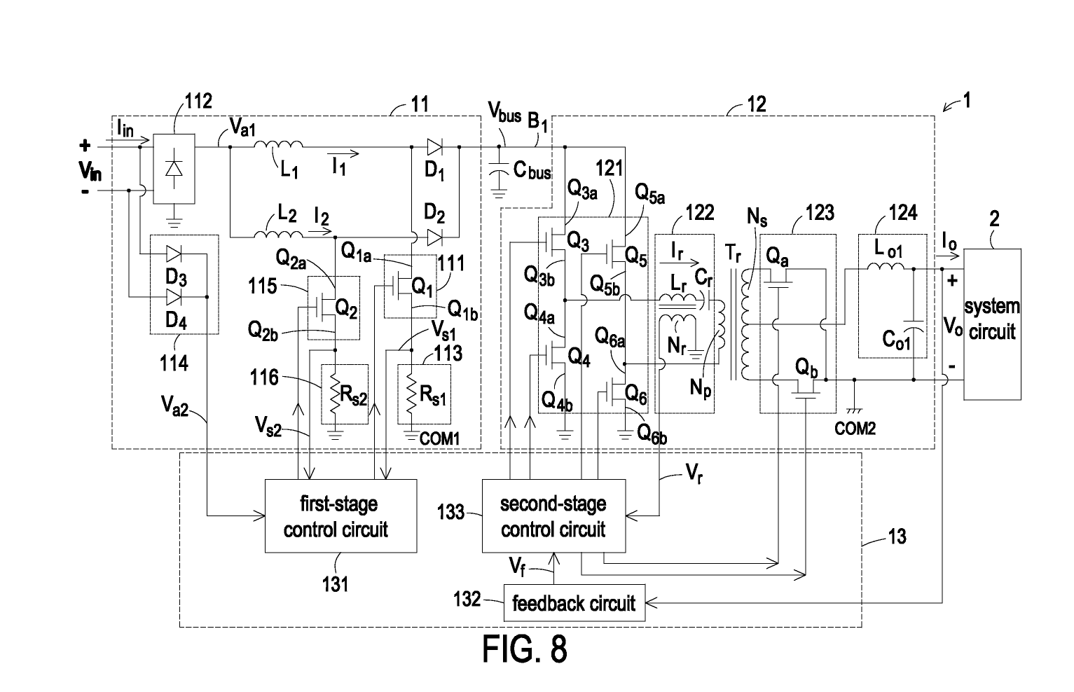

FIG. 8 is a schematic detailed circuit diagram of a third exemplary two-stage switching power supply as shown in FIG. 1. In comparison with FIG. 7, the second switching circuit 121 of FIG. 8 further comprises a fifth switch element Q₅ and a sixth switch element Q₆. In other words, the second switching circuit 121 of FIG. 7 has a half-bridge configuration but the second switching circuit 121 of FIG. 8 has a full-bridge configuration. A first terminal Q₅ₐ of the fifth switch element Q₅ is connected to the power bus B₁, the bus capacitor C_{bus}, and the first terminal Q₃ₐ of the third switch element Q₃. A second terminal Q_{5b} of the fifth switch element Q₅ is connected to a first terminal Q₆ₐ of the sixth switch element Q₆ and the secondary winding assembly Nₛ of the isolation transformer Tᵣ. A second terminal Q_{6b} of the sixth switch element Q₆ is connected to the first common terminal COM₁. The control terminals of the fifth switch element Q₅ and the sixth switch element Q₆ are connected to the second-stage control circuit 133.

In an embodiment, the third switch element Q₃ and the sixth switch element Q₆ are simultaneously conducted or shut off according to the first control signal V_{D1}. In addition, the fourth switch element Q₄ and the fifth switch element Q₅ are simultaneously conducted or shut off according to the second control signal V_{D2}. Since the first control signal V_{D1} and the second control signal V_{D2} are not simultaneously in the enabling status, the third switch element Q₃ and the fourth switch element Q₄ will not be simultaneously conducted, and the sixth switch element Q₆ and the fifth switch element Q₅ will not be simultaneously conducted.

Similarly, according to the first control signal V_{D1} and the second control signal V_{D2}, the third switch element Q₃, the fourth switch element Q₄, the fifth switch element Q₅ and the sixth switch element Q₆ are conducted or shut off under control of the second-stage control circuit 133. As such, the electrical energy of the bus voltage V_{bus} will be selectively transmitted to the resonant circuit 122 and the primary winding assembly Nₚ of the isolation transformer Tᵣ through the third switch element Q₃, the fourth switch element Q₄, the fifth switch element Q₅ and the sixth switch element Q₆. As such, both ends of the primary winding assembly Nₚ are subject to a voltage variation. Due to the voltage variation, a secondary winding assembly Nₛ of the isolation transformer Tᵣ generates an induction voltage. The relation between the electricity consumption amount Pₒ of the system circuit 2, the power-consuming status and operating mode of the second switching circuit 121 has been described above.

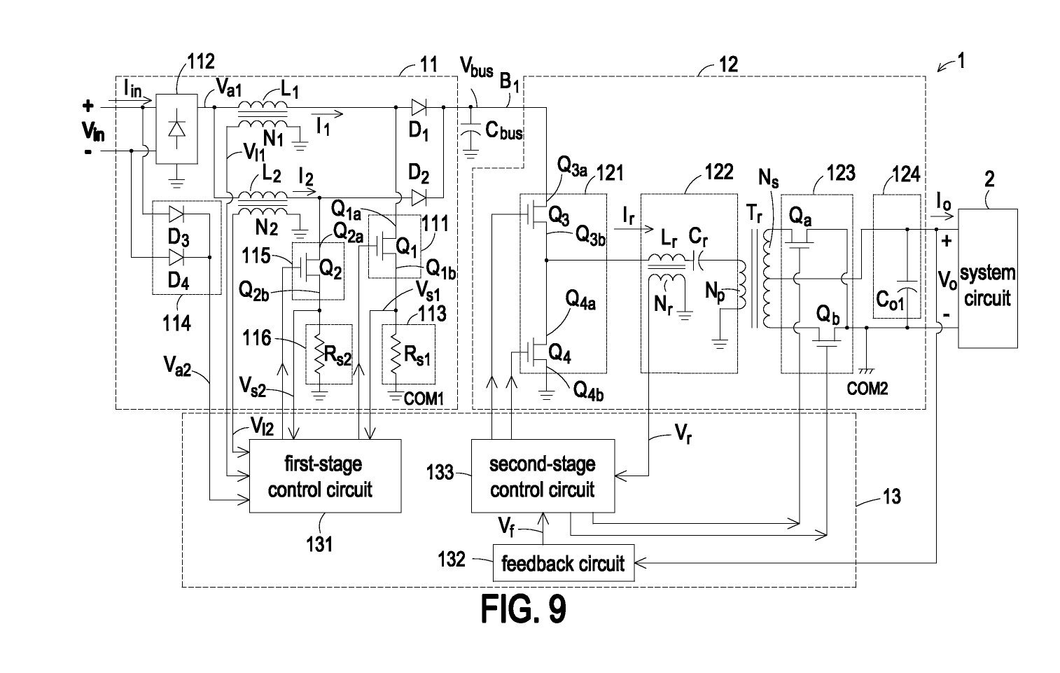

FIG. 9 is a schematic detailed circuit diagram of a fourth exemplary two-stage switching power supply as shown in FIG. 1. In comparison with FIG. 7, the first boost inductor L₁ and the second boost inductor L₂ of the first-stage power circuit 11 of FIG. 9 further comprise a first inductive winding coil N₁ and a second inductive winding coil N₂, respectively. The first inductive winding coil N₁ of the first boost inductor L₁ and the second inductive winding coil N₂ of the second boost inductor L₂ are respectively connected to the first-stage control circuit 131.

According to the first current I₁ passing through the first boost inductor L₁, the first inductive winding coil N₁ of the first boost inductor L₁ generates a first induction current detecting signal V_{I1}. According to the second current I₂ passing through the second boost inductor L₂, the second inductive winding coil N₂ of the second boost inductor L₂ generates a second induction current detecting signal V_{I2}. According to the first induction current detecting signal V_{I1} and the second induction current detecting signal V_{I2}, the first-stage control circuit 131 could discriminate the statuses of the first current I₁ and the second current I₂. In addition, according to the first induction current detecting signal V_{I1} and the second induction current detecting signal V_{I2}, the first-stage control circuit 131 could discriminate the electricity consumption amount Pₒ of the system circuit 2. The relation between the magnitude of the bus voltage V_{bus} and the electricity consumption amount Pₒ of the system circuit 2 has been described above.

It is noted that, however, those skilled in the art will readily observe that numerous modifications and alterations may be made while retaining the teachings of the invention. For example, the first-stage power circuit 11 of the two-stage switching power supply 1 could be a boost-type power circuit, a buck-type power circuit, or a buck-boost type power circuit. The second-stage power circuit 12 of the two-stage switching power supply 1 could be a LLC resonant circuit or a LCC resonant circuit.

In the above embodiments, the first-stage control circuit 131 and the second-stage control circuit 133 of the power control unit 13 are illustrated by referring to PWM controllers. Nevertheless, the first-stage control circuit 131 and the second-stage control circuit 133 of the power control unit 13 could be pulse frequency modulation (PFM) controllers or digital signal processors (DSPs). In some embodiments, the first-stage control circuit 131 and the second-stage control circuit 133 could be integrated into a single chip.

An example of each of the first switch element Q₁, the second switch element Q₂, the third switch element Q₃, the fourth switch element Q₄, the fifth switch element Q₅, the sixth switch element Q₆, the first rectifying switch element Qₐ and the second rectifying switch element Q_{b} includes but is not limited to a bipolar junction transistor (BJT) or a metal oxide semiconductor field effect transistor (MOSFET).

From the above description, the bus voltage outputted from the first-stage power circuit of the two-stage switching power supply of the present invention is not constant. The magnitude of the bus voltage is linearly or stepwise altered as the electricity consumption amount of the system circuit. The second-stage power circuit of the two-stage switching power supply of the present invention is selectively operated in a PWM mode or a resonant mode according to the electricity consumption amount of the system circuit. In the low electricity consumption status, the second switching circuit is operated in the PWM mode. In the non-low electricity consumption status, the second switching circuit is operated in the resonant mode. As a consequence, the two-stage switching power supply of the present invention has high operating efficiency when the electricity consumption amount of the system circuit is high or low.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A two-stage switching power supply for receiving an input voltage and generating an output voltage or an output current to a system circuit, said two-stage switching power supply comprising:
a first-stage power circuit connected to a power bus for receiving an input voltage, and comprising a first switching circuit, wherein said input voltage is converted into a bus voltage by alternately conducting and shutting off said first switching circuit;
a bus capacitor interconnected between said power bus and a first common terminal for storing electrical energy;
a second-stage power circuit connected to said power bus for receiving said bus voltage, and comprising a second switching circuit, wherein said bus voltage is converted into said output voltage or said output current by alternately conducting and shutting off said second switching circuit; and
a power control unit connected to a control terminal of said first switching circuit of said first-stage power circuit, a control terminal of said second switching circuit of said second-stage power circuit and a power bus for controlling operations of said first switching circuit and said second switching circuit, wherein said bus voltage is dynamically adjusted according to electricity consumption amount of said system circuit under control of said power control unit, and an operating mode of said second switching circuit of said second-stage power circuit is changed according to said electricity consumption amount of said system circuit.

2. The two-stage switching power supply according to claim 1 wherein said power control unit discriminates whether said system circuit is in a low electricity consumption status or a non-low electricity consumption status according to said electricity consumption amount of said system circuit.

3. The two-stage switching power supply according to claim 2 wherein said operating mode of said second switching circuit is a pulse width modulation mode or a resonant mode.

4. The two-stage switching power supply according to claim 3 wherein when said system circuit is in said low electricity consumption status, the duty cycle of said second switching circuit is adjusted by said power control unit such that said second switching circuit is operated in said pulse width modulation mode.

5. The two-stage switching power supply according to claim 3 wherein when said system circuit is in said non-low electricity consumption status, the duty cycle of said second switching circuit is adjusted by said power control unit such that said second switching circuit is operated in said resonant mode.

6. The two-stage switching power supply according to claim 2 wherein said power control unit discriminates that said system circuit is in said low electricity consumption status when said electricity consumption amount of said system circuit is lower than a first electricity consumption amount.

7. The two-stage switching power supply according to claim 6 wherein said power control unit discriminates that said system circuit is in said non-low electricity consumption status when said electricity consumption amount of said system circuit is higher than a second electricity consumption amount.

8. The two-stage switching power supply according to claim 7 wherein said power control unit discriminates occurrence of a hysteresis when said first electricity consumption amount is equal to said second electricity consumption amount, and said power control unit discriminates no occurrence of a hysteresis when said first electricity consumption amount is not equal to said second electricity consumption amount.

9. The two-stage switching power supply according to claim 1 wherein the magnitude of said bus voltage is in direction proportion to said electricity consumption amount of said system circuit.

10. The two-stage switching power supply according to claim 1 wherein the magnitude of said bus voltage is linearly or stepwise changed with said electricity consumption amount of said system circuit.

11. The two-stage switching power supply according to claim 10 wherein a plurality of electricity consumption regions is defined by said power control unit according to a rated output power value of said two-stage switching power supply, and the magnitude of said bus voltage is determined according to said electricity consumption region corresponding to said electricity consumption amount of said system circuit.

12. The two-stage switching power supply according to claim 1 wherein said first-stage power circuit further comprises:
a first input rectifier circuit for rectifying said input voltage, thereby generating a first rectified input voltage;
a first boost inductor having a first end connected to said first input rectifier circuit and a second end connected to said first switching circuit;
a first diode having an anode connected to said second end of said first boost inductor and said first switching circuit, and a cathode connected to said power bus; and
a first current detecting circuit interconnected between said first switching circuit and a first common terminal for detecting a charging current flowing through said first boost inductor, thereby generating a first current detecting signal,
wherein said first switching circuit comprises a first switch element, a first terminal of said first switch element is connected to said anode of said first diode and said second end of said first boost inductor, a second terminal of said first switch element is connected to said first current detecting circuit, and a control terminal of said first switch element is connected to said power control unit.

13. The two-stage switching power supply according to claim 12 wherein said first-stage power circuit further comprises:
a second input rectifier circuit for rectifying said input voltage, thereby generating a second rectified input voltage;
a second boost inductor having a first end connected to said first input rectifier circuit;
a second diode having an anode connected to a second end of said second boost inductor and a cathode connected to said power bus;
a third switching circuit comprising a second switch element, wherein a first terminal of said second switch element is connected to said anode of said second diode and said second terminal of said second boost inductor, and a control terminal of said second switch element is connected to said power control unit; and
a second current detecting circuit interconnected between said third switching circuit and said first common terminal for detecting a charging current flowing through said second boost inductor, thereby generating a second current detecting signal,
wherein said first switching circuit and said third switching circuit are sequentially or alternately conducted under the control of said power control unit.

14. The two-stage switching power supply according to claim 13 wherein said first current detecting circuit comprises a first current detecting resistor, and said second current detecting circuit comprises a second current detecting resistor.

15. The two-stage switching power supply according to claim 1 wherein said second-stage power circuit comprises:
a resonant circuit connected to said second switching circuit;
an isolation transformer having a primary winding assembly connected with said resonant circuit;
an output rectifier circuit connected with a secondary winding assembly of said isolation transformer for rectification; and
an output filter circuit interconnected between said output rectifier circuit and said system circuit.

16. The two-stage switching power supply according to claim 15 wherein said second switching circuit comprises:
a third switch element having a first terminal connected to said power bus and a control terminal connected to said power control unit; and
a fourth switch element having a first terminal connected to a second terminal of said third switch element and said resonant circuit, a second terminal connected to said first common terminal, and a control terminal connected to said power control unit,
wherein said third switch element and said fourth switch element are conducted or shut off under control of said power control unit, so that electrical energy of said bus voltage is selectively transmitted to said resonant circuit and said primary winding assembly of said isolation transformer through said third switch element and said fourth switch element.

17. The two-stage switching power supply according to claim 16 wherein said second switching circuit comprises:
a fifth switch element having a first terminal connected to said power bus and said first terminal of said third switch element, and a control terminal connected to said power control unit; and
a sixth switch element having a first terminal connected to a second terminal of said fifth switch element and said primary winding assembly of said isolation transformer, a second terminal connected to said first common terminal, and a control terminal connected to said power control unit,
wherein said third switch element, said fourth switch element, said fifth switch element and said sixth switch element are conducted or shut off under control of said power control unit, so that electrical energy of said bus voltage is selectively transmitted to said resonant circuit and said primary winding assembly of said isolation transformer through said third switch element, said fourth switch element, said fifth switch element and said sixth switch element.

18. The two-stage switching power supply according to claim 15 wherein said resonant circuit comprises a resonant inductor and a resonant capacitor, said resonant inductor and said resonant capacitor are serially connected between said second switching circuit and said primary winding assembly of said isolation transformer, and a resonant relation is established between said resonant circuit and said primary winding assembly of said isolation transformer by adjusting said operating mode of said second switching circuit, so that both ends of said primary winding assembly of said isolation transformer are subject to a voltage variation.

19. The two-stage switching power supply according to claim 18 wherein said resonant circuit further comprises an induction coil, and said induction coil is connected to said power control unit and subject to induction by an induction current, thereby generating a resonant current detecting signal, wherein said power control unit discriminates whether said second-stage power circuit is in an over current protection status according to said resonant current detecting signal.

20. The two-stage switching power supply according to claim 15 wherein said output rectifier circuit is a synchronous rectifier circuit and comprises:
a first rectifying switch element interconnected between a first end of said secondary winding assembly of said isolation transformer and a second common terminal; and
a second rectifying switch element interconnected between a second end of said secondary winding assembly of said isolation transformer and said second common terminal,
wherein a control terminal of said first rectifying switch element and a control terminal of said second rectifying switch element are connected to said power control unit, and said first rectifying switch element and said second rectifying switch element are selectively conducted or shut off under control of said power control unit, thereby rectifying an induction voltage that is generated by said secondary winding assembly of said isolation transformer.

21. The two-stage switching power supply according to claim 15 wherein said output filter circuit comprises a first capacitor for filtering a voltage that is rectified by said output rectifier circuit, thereby generating said output voltage or said output current to said system circuit, wherein a first end of said first capacitor is connected to said output rectifier circuit, a second end of said first capacitor is connected to a center-tapped head of said secondary winding assembly of said isolation transformer.

22. The two-stage switching power supply according to claim 1 wherein said power control unit comprises:
a first-stage control circuit connected to said control terminal of said first switching circuit and said power bus for generating a first power factor correction signal, wherein said first-stage control circuit controls operations of said first switching circuit according to said first power factor correction signal, so that the magnitude of said bus voltage is dynamically adjusted according to said electricity consumption amount of said system circuit;
a feedback circuit connected to a power output terminal of said second-stage control circuit, wherein said feedback circuit generates a feedback signal according to said output voltage or said output current; and
a second-stage control circuit connected to said control terminal of said second switching circuit and said feedback circuit for generating a first control signal, wherein said second-stage control circuit controls operations of said second switching circuit according to first control signal, and said first control signal is dynamically adjusted to change said operating mode of said second switching circuit according to said electricity consumption amount of said system circuit.

23. The two-stage switching power supply according to claim 22 wherein each of said first-stage control circuit and said second-stage control circuit is pulse width modulation controller, pulse frequency modulation controller or digital signal processor.

24. The two-stage switching power supply according to claim 1 wherein said first-stage power circuit comprises a boost-type power circuit, a buck-type power circuit or a buck-boost type power circuit, and said second-stage power circuit comprises a LLC resonant circuit or a LCC resonant circuit.
